(19) United States
(12) Patent Application Publication
(10) Pub. No.: US 2026/0023286 A1
(43) Pub. Date: Jan. 22, 2026

(54) DISPLAY DEVICE

(71) Applicant: Japan Display Inc., Tokyo (JP)

(72) Inventor: Kentaro OKUYAMA, Tokyo (JP)

(21) Appl. No.: 19/247,797

(22) Filed: Jun. 24, 2025

(30) Foreign Application Priority Data
Jul. 18, 2024 (JP) 2024-114899

(51) Int. Cl. G02F 1/1337; G02F 1/1334

(52) U.S. Cl. CPC G02F 1/1337; G02F 1/1334

(57) ABSTRACT

A display device according to an embodiment of the present invention includes a display panel including a first substrate, a second substrate, and a liquid crystal layer between the first substrate and the second substrate; and a light source arranged around the display panel, wherein at least a part of a periphery of the display panel has a curved portion in a plan view, the liquid crystal layer contains liquid crystal molecules and a polymer, and part of the liquid crystal molecules are aligned along the curved portion.

### CROSS-REFERENCE TO RELATED APPLICATIONS

This application claims the benefit of priority to Japanese Patent Application No. 2024-114899, filed on Jul. 18, 2024, the entire contents of which are incorporated herein by reference.

### FIELD

The present invention relates to a display device.

### BACKGROUND

In recent years, polymer dispersed liquid crystal (PDLC) displays have attracted attention. The display device using PDLC described in Japanese Laid-Open Patent Publication No. 2020-144272 is in a transparent state when no voltage is applied, and enables, for example, an opaque white state or a color display when a voltage is applied. A PDLC type display device (hereinafter, referred to as a PDLC display device) using this characteristic can also be used as a dimming device, and, for example, daylighting and shading of glass windows can be realized by turning on and off a power source. Further, the PDLC display device can realize a wide viewing angle without using a polarizing plate.

### SUMMARY

According to an embodiment of the present invention, a display device is provided including a display panel including a first substrate, a second substrate, and a liquid crystal layer between the first substrate and the second substrate, and a light source arranged around the display panel, wherein at least a part of a periphery of the display panel has a curved portion in a plan view, the liquid crystal layer contains liquid crystal molecules and a polymer, and a part of the liquid crystal molecules is aligned along a curve corresponding to the curved portion.

According to an embodiment of the present invention, a display device is provided including a display panel including a first substrate, a second substrate, and a liquid crystal layer between the first substrate and the second substrate, and a light source arranged around the display panel, wherein the liquid crystal layer includes liquid crystal molecules and a polymer, the display panel has a polygonal shape other than a square, the light source is arranged along at least one side of the display panel, and at least a part of the liquid crystal molecules is aligned along the at least one side of the display panel. According to an embodiment of the present invention, a method for manufacturing a display device is provided including performing an alignment process on an alignment film formed on one surface of a substrate, wherein at least a part of an outer edge portion of the alignment film has an arc shape, and the alignment process includes performing an alignment process on at least a part of a surface to be aligned of the alignment film along a circumferential direction of the arc shape.

According to an embodiment of the present invention, a method for manufacturing a display device is provided including performing an alignment process on an alignment film formed on one surface of a substrate, wherein the alignment film has a polygonal shape other than a square, and the alignment process includes performing an alignment process on at least a part of a surface to be aligned of the alignment film along at least two sides of the polygonal shape.

### BRIEF DESCRIPTION OF DRAWINGS

FIG. 1 is a plan view showing an example of a display device according to an embodiment.

FIG. 2 is a cross-sectional view showing part of a configuration of a pixel of a display device according to an embodiment.

FIG. 3 is a diagram for explaining an alignment process direction of an alignment film according to an embodiment.

FIG. 4 is a flowchart showing an example of a method for manufacturing a display device according to an embodiment.

FIG. 5 is a plan view showing an example of a display device according to an embodiment.

FIG. 6 is a diagram for explaining an alignment process direction of an alignment film according to an embodiment.

FIG. 7 is an example of a plan view of a display panel according to a modification.

FIG. 8 is an example of a plan view of a display panel according to a modification.

FIG. 9 is a diagram for explaining an alignment process direction of an alignment film used in the display panel shown in FIG. 8.

FIG. 10 is a plan view showing an example of a display device according to a modification.

FIG. 11 is a diagram for explaining an alignment process direction of an alignment film used in a display panel shown in FIG. 10.

FIG. 12 is a plan view showing an example of a display device according to a modification.

FIG. 13 is a diagram for explaining an alignment process direction of an alignment film used in a display panel shown in FIG. 12.

FIG. 14 is a diagram for explaining an alignment process direction of an alignment film according to a modification.

### DESCRIPTION OF EMBODIMENTS

It is known that an edge-light type PDLC display device in which a light source is arranged at an end portion of a display panel can achieve a higher transmittance. In an edge-light type PDLC display device, a direction in which light from an LED light source travels is perpendicular to a direction of alignment of liquid crystal molecules in a liquid crystal layer, thereby achieving a high-efficiency and high-luminance display panel.

In the case where a display panel having at least a part of a curved portion is used in a PDLC display device, it is conceivable to arrange LED light sources along a periphery of the display panel. In this case, if an alignment direction of liquid crystal molecules is aligned in one direction in the entire liquid crystal display panel, in other words, if the liquid crystal alignment process is performed in one axial direction relative to a substrate, an angle formed between a traveling direction of the light from the LED light source and an alignment direction of the liquid crystal molecules in the liquid crystal layer is not perpendicular for some positions, and thus there is a possibility that luminance unevenness may occur in the display panel. In addition, in the case of not only a display panel having at least a part of a curved portion but also a polygonal display panel other than a square or an asymmetrical rectangular display panel, luminance unevenness may occur in the display panel in the same manner.

According to the present disclosure, it is possible to provide a PDLC display device having uniform display properties and a manufacturing process thereof.

Hereinafter, embodiments of the present invention will be described with reference to the drawings and the like. However, the present invention can be implemented in various aspects without departing from the gist thereof, and is not to be construed as being limited to the description of the embodiments exemplified below. Further, in order to clarify the description with respect to the drawings, although the width, the thickness, the shape, and the like of each part may be schematically represented in comparison with the actual embodiment, the schematic drawings are merely examples, and do not limit the interpretation of the present invention.

In the present specification and the drawings, elements that are the same as or similar to those described with respect to the drawings described above are denoted by the same reference signs, and redundant descriptions thereof may be omitted. In this specification and the like, ordinal numbers are given for convenience in order to distinguish parts, components, and the like, and do not indicate priority or order. In addition, in the case where a plurality of identical elements are arranged, in the case where it is necessary to distinguish individual elements, each element may be distinguished by adding a different letter after a reference sign indicating the element. However, in the case where it is not necessary to distinguish each element, a letter is omitted from a reference sign indicating an element in some cases.

In addition, in this specification and the like, expressions such as “up” and “down” represent relative positional relationships between a structure of interest and other structures. In this specification and claims, unless otherwise specified, an expression “above” in describing a manner of placing a structure on another structure shall include both placing the structure directly above the other structure so as to be in contact with the structure and placing the structure on top of the other structure, with another structure in between.

In each embodiment, the expression “a comprises A, B, or C,” “a comprises any of A, B, or C,” “a comprises one selected from a group consisting of A, B, and C” does not exclude the case where a comprises a plurality of combinations of A to C unless otherwise indicated. Furthermore, these expressions do not exclude the case where a includes other elements.

### First Embodiment

### [Configuration of PDLC Display Device]

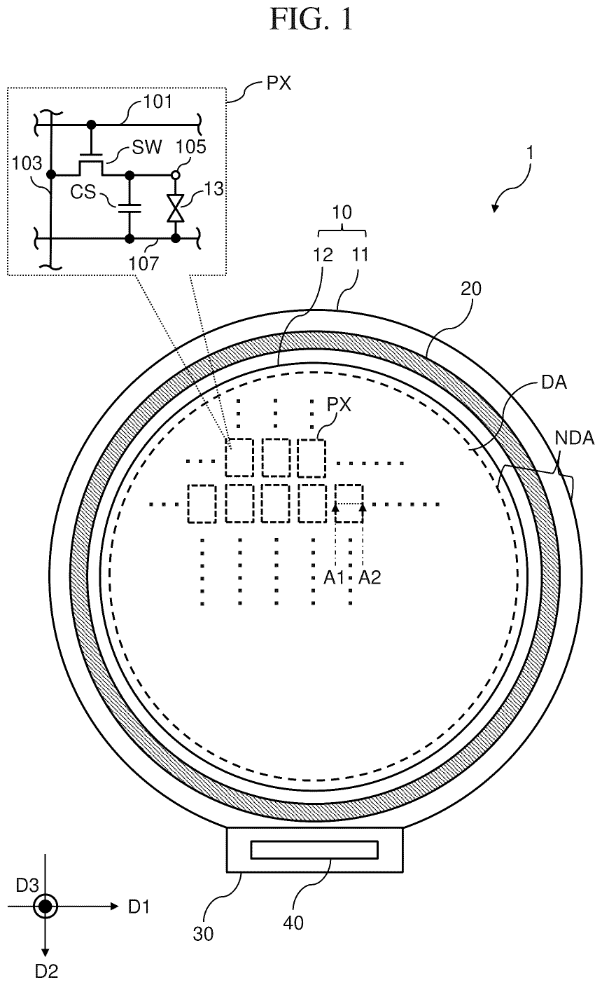

FIG. 1 is a plan view showing an example of a display device 1 according to an embodiment of the present invention. The display device 1 is a PDLC display device using a polymer dispersed liquid crystal. In the present embodiment, a case where the display device 1 is a reverse mode driving system will be described. In FIG. 1, a first direction D1, a second direction D2, and a third direction D3 are perpendicular to each other. The first direction D1 and the second direction D2 are directions parallel to a surface of a display panel 10 of the display device 1, and the third direction D3 is a thickness direction of the display panel 10. In the present embodiment, viewing a plane D1-D2 defined by the first direction D1 and the second direction D2 from the third direction D3 side is referred to as a plan view.

The display device 1 includes the display panel 10, a light source 20, a wiring substrate 30, and a driver IC 40.

The display panel 10 includes a first substrate 11, a second substrate 12, and a liquid crystal layer 13 sandwiched between the first substrate 11 and the second substrate 12. The display panel 10 has a curved portion, for example, an arc shape, on at least a part of a periphery (for example, at least a part of an outer edge). In the present embodiment, as an example, a case where the display panel 10 has a circular shape as a whole in a plan view will be described.

The first substrate 11 and the second substrate 12 are circular substrates. The second substrate 12 overlaps at least a part of the first substrate 11 and is bonded to the first substrate 11 in a state of being separated from each other by a sealing material (not shown). The liquid crystal layer 13 is held between the first substrate 11 and the second substrate 12, and is sealed with a sealing material. Electrodes and alignment films are formed on the first substrate 11 and the second substrate 12, respectively.

The display panel 10 includes a display area DA and a non-display area NDA, and the display area DA has a circular shape along the shape of the display panel 10. The non-display area NDA is arranged so as to surround the display area DA. Although not shown, the sealing material that seals the liquid crystal layer and adheres the first substrate 11 and the second substrate 12 to each other is arranged in the non-display area NDA.

The display area DA includes a plurality of pixels PX. In the display area DA, the plurality of pixels PX are arranged in a matrix in the first direction D1 and the second direction D2. The pixel PX includes a switching element SW, a pixel electrode 105, a common electrode 107, and the liquid crystal layer 13. The switching element SW is formed of, for example, a thin film transistor (TFT), and is electrically connected to a gate line 101 and a data line 103. The gate line 101 is electrically connected to the switching element SW in each of the pixels PX arranged in the first direction D1. On the other hand, the data line 103 is electrically connected to the switching element SW in each of the pixels PX arranged in the second direction D2. The pixel electrode 105 is electrically connected to the switching element SW. The common electrode 107 is provided in common to a plurality of pixel electrodes 105. The pixel electrodes 105 face the common electrode 107 in the third direction D3.

Liquid crystal molecules (not shown) included in the liquid crystal layer 13 are driven by an electric field generated between the pixel electrode 105 and the common electrode 107. Details of the liquid crystal layer 13 will be described later.

Capacitance CS is formed, for example, between an electrode having the same potential as the common electrode 107 and an electrode having the same potential as the pixel electrode 105.

The gate line 101, the data line 103, the switching element SW, and the pixel electrode 105 are arranged on the first substrate 11. The common electrode 107 is arranged on the second substrate 12. In the first substrate 11, the gate line 101 and the data line 103 are electrically connected to the driver IC 40 via the wiring substrate 30.

The wiring substrate 30 is connected to the non-display area NDA. The wiring substrate 30 is a flexible printed circuit (FPC) board. The driver IC 40 is electrically connected to the wiring substrate 30. The driver IC 40 includes, for example, a driving circuit such as a gate driving circuit electrically connected to the gate line 101 and a data driving circuit electrically connected to the data line 103. In addition, the driver IC 40 may be electrically connected to the non-display area NDA.

In the non-display area NDA, the light source 20 may be continuously arranged so as to surround the display area DA, or may be intermittently arranged. The light source 20 includes a plurality of light emitting diodes (LEDs) that emit light toward the display area DA. A timing of light emission of the light source 20 is controlled by a light emitting control circuit (not shown) synchronized with the gate driving circuit and the data driving circuit. The light source 20 and the light emitting control circuit may be provided as separate members (light emitting units) independent of the display panel 10. In addition, the light emitting control circuit may be incorporated in the gate driving circuit or the data driving circuit.

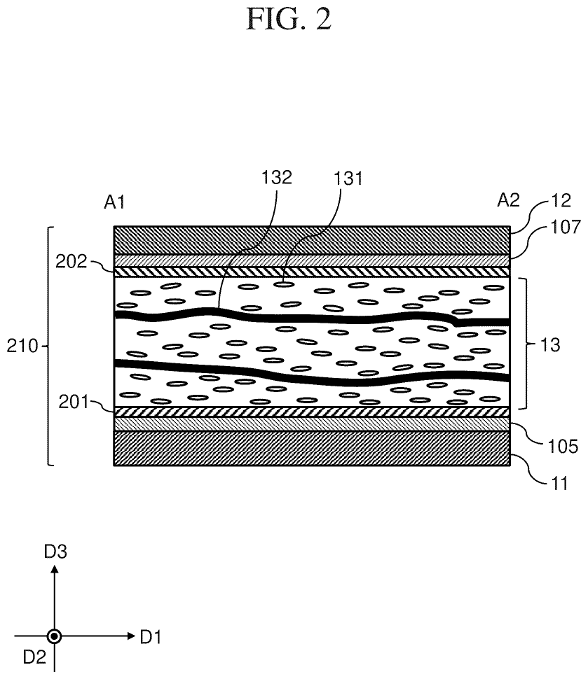

FIG. 2 is a cross-sectional view showing a part of a configuration of the pixel PX, and is a schematic view corresponding to a cross section between A1-A2 shown in FIG. 1. In the pixel PX, the pixel electrode 105 and a first alignment film 201 are arranged on the first substrate 11. The common electrode 107 opposed to the pixel electrode 105 and a second alignment film 202 are arranged on the second substrate 12. The liquid crystal layer 13 is sandwiched between the first substrate 11 and the second substrate 12, and is arranged between the first alignment film 201 and the second alignment film 202 facing each other. The first substrate 11, the pixel electrode 105, the first alignment film 201, the liquid crystal layer 13, the second alignment film 202, the common electrode 107, and the second substrate 12 form a liquid crystal cell 210.

A data voltage applied from the data driving circuit via the data line 103 is applied to the pixel electrode 105. A predetermined voltage is applied to the common electrode 107. The pixel electrode 105 and the common electrode 107 are transparent electrodes such as ITO (Indium Tin Oxide), IZO (Indium Zinc Oxide), or the like.

The liquid crystal layer 13 is comprised of polymer-dispersed liquid crystal and includes liquid crystal molecules 131 and a polymer structure 132. The polymer structure 132 is formed from a polymer formed by polymerizing a photopolymerizable monomer. The photopolymerizable monomer is, for example, a photocurable resin such as an ultraviolet curable resin. In addition, the photopolymerizable monomer preferably has liquid crystallinity from a viewpoint of alignment and transparency. The polymer structure 132 is fibrous (streaky) and is arranged so as to extend along an extending direction of the gate line 101 in the liquid crystal layer 13. The liquid crystal molecules 131 are separated from the polymer structure 132 and dispersed between the polymer structures 132 in the liquid crystal layer 13. The liquid crystal molecules 131 and the polymer structure 132 have optical anisotropy or refractive index anisotropy, respectively. The polymer structure 132 is less responsive to an electric field than the liquid crystal molecules 131 are. For example, an alignment direction of the polymer structure 132 hardly changes regardless of presence or absence of an electric field. On the other hand, the alignment direction of the liquid crystal molecules 131 changes according to the magnitude of the electric field in a state where a voltage equal to or higher than a threshold value is applied to the liquid crystal layer 13.

A scattering state and a non-scattering state of the liquid crystal layer 13 are controlled for each pixel PX. Here, the “scattering state” refers to a state in which the liquid crystal molecules 131 are aligned so that light incident in the liquid crystal layer 13 is scattered, and the “non-scattering state” refers to a state in which the liquid crystal molecules 131 are aligned so that the incident light passes through the liquid crystal layer 13 without being scattered. In a state in which no voltage is applied to the liquid crystal layer 13, optical axes of the liquid crystal molecules 131 and the polymer structure 132 are parallel to each other, and the light incident in the liquid crystal layer 13 is transmitted through the liquid crystal layer 13 almost without being scattered (non-scattering state). On the other hand, in a state in which a voltage is applied to the liquid crystal layer 13, the optical axis of the liquid crystal molecules 131 and the optical axis of the polymer structure 132 intersect each other. As a result, the light incident in the liquid crystal layer 13 is scattered (scattering state) in the liquid crystal layer 13. The “scattering state” and the “non-scattering state” are controlled by the magnitude of an electric field between the pixel electrode 105 and the common electrode 107 generated when a voltage is applied to the pixel electrode 105 and the common electrode 107. FIG. 2 shows the liquid crystal layer 13 in the “non-scattering state”.

When light is incident on the display panel 10 from the light source 20, at least a part of the light traveling while passing through the display panel 10 is scattered when the light passes through the pixel PX in which the liquid crystal layer 13 is in the scattering state. In this case, some of the scattered light is emitted to the outside without being totally reflected, and is visible by the user of the display device 1. On the other hand, since no scattered light is generated in the pixel PX in which the liquid crystal layer 13 is in the non-scattering state, the incident light passes through the pixel PX and passes directly to a back side (a side opposite to a side where a user exists). That is, the user can visually recognize the back side through the display device 10.

The display device 1 displays images to the user by causing the liquid crystal layer 13 of a particular pixel PX to be in the scattering state and emit scattered light. In addition, other pixels PX other than the particular pixel PX are in the non-scattering state, so that scattered light is not generated and is recognized as transparent pixels by the user.

The first alignment film 201 and the second alignment film 202 have circular shapes matching the shape of the display area DA. At least a part of the aligned surfaces of the first alignment film 201 and the second alignment film 202 is aligned along a circumferential direction of the first alignment film 201 and the second alignment film 202.

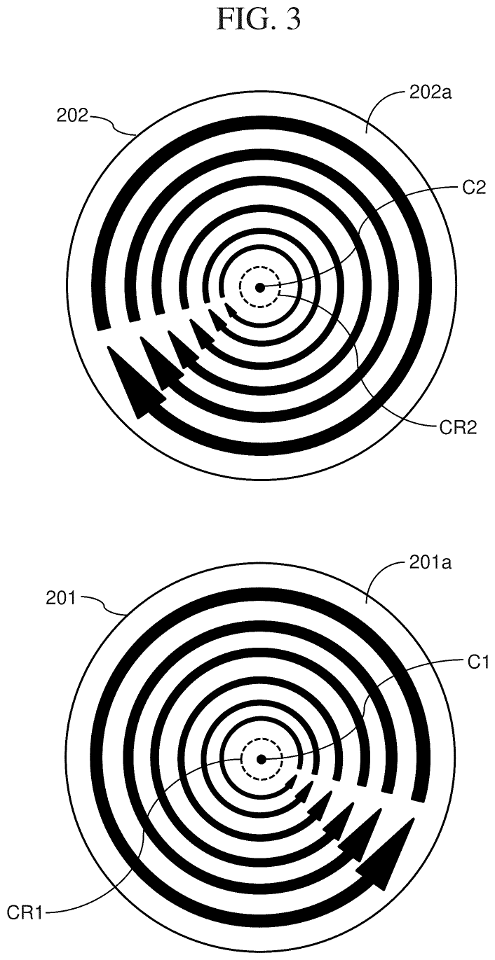

FIG. 3 is a diagram for explaining alignment process directions of the first alignment film 201 and the second alignment film 202. Hereinafter, a surface to be subjected to the alignment process in each alignment film is referred to as a “surface to be aligned”. A surface to be aligned 201a of the first alignment film 201 is subjected to an alignment process in a counterclockwise direction along the circumferential direction of the first alignment film 201. On the other hand, a surface to be aligned 202a of the second alignment film 202 is subjected to an alignment process in a clockwise direction along the circumferential direction of the second alignment film 202. That is, the alignment process direction of the surface to be aligned 201a of the first alignment film 201 and the alignment process direction of the surface to be aligned 202a of the second alignment film 202 are opposite to each other. In other words, the liquid crystal cell 210 is an ECB mode-liquid crystal cell. The surface to be aligned 201a of the first alignment film 201 and the surface to be aligned 202a of the second alignment film 202 face each other with the liquid crystal layer 13 interposed therebetween. In addition, the alignment process direction of the first alignment film 201 may be a clockwise direction, and the alignment process direction of the second alignment film 202 may be a counterclockwise direction.

By aligning the surface to be aligned 201a of the first alignment film 201 and the surface to be aligned 202a of the second alignment film 202 along the circumferential direction, the alignment process direction and the traveling direction of the light entering the liquid crystal layer 13 from the light source 20 arranged around the display area DA are perpendicular to each other in substantially the entire area of the display area DA. Therefore, in the case where the pixel PX is in the scattering state, regardless of the position of the pixel PX in the display area DA, an angle formed by the traveling direction of the light from the light source 20 and the alignment direction of the liquid crystal molecules 131 in the liquid crystal layer 13 is perpendicular to substantially the entire area of the display area DA. In other words, the light from the light source 20 is orthogonal to the alignment direction of at least a part of the liquid crystal molecules 131. As a result, it is possible to reduce luminance unevenness in the display panel 10, realize high efficiency and high luminance of the display panel 10, and provide the display device 1 having uniform display characteristics.

In the present embodiment, the surfaces to be aligned 201a and 202a of the first alignment film 201 and the second alignment film 202 are subjected to the alignment process by rubbing or photo-alignment. In this case, regions CR1 and CR2 in the vicinity of a center including centers C1 and C2 of the surfaces to be aligned 201a and 202a of the first alignment film 201 and the second alignment film 202 (hereinafter, referred to as the center region CR1 and the center region CR2) may not be subjected to the alignment process in the circumferential direction, and the center regions CR1 and CR2 may not be subjected to the alignment process.

The centers C1 and C2 correspond to a rotation axis of a rubbing brush or rotation axes of the first substrate 11 and the second substrate 12 on which the alignment films 201 and 202 are formed when the alignment process of the alignment films 201 and 202 is performed, and the center regions CR1 and CR2 are regions near the rotation axes. Therefore, the center regions CR1 and CR2 are less likely to be subjected to the circumferential alignment process when the alignment process is performed. However, the center regions CR1 and CR2 are very narrow regions in the entire alignment films 201 and 202, and the alignment of the liquid crystal molecules 131 in the center regions CR1 and CR2 is continuously changed from the alignment direction of the liquid crystal molecules 131 in the surrounding region, rather than changed drastically. Therefore, the luminance of the display panel 10 is not greatly affected even if the alignment process is not performed in the center regions CR1 and CR2.

### [Manufacturing Method for Display Device]

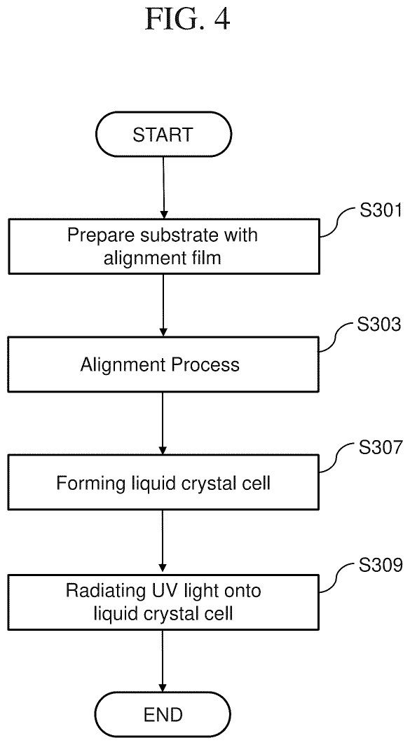

FIG. 4 is a flowchart showing an example of a manufacturing method for the display device 1 according to the present embodiment. In FIG. 4, the “substrate” is the first substrate 11 or the second substrate 12, and the “alignment film” is the first alignment film 201 or the second alignment film 202.

First, a substrate having an alignment film formed on one surface thereof is prepared (S301). The alignment film can be formed by coating an alignment film material such as polyimide on a transparent electrode (the pixel electrode 105 or the common electrode 107) formed on one surface of the substrate by a printing method, a spin coating method, or the like, and baking.

Next, the alignment film is subjected to the alignment process (S303). The alignment process may be the rubbing process using the rubbing brush or a photo-alignment process using circularly polarized irradiation of ultraviolet rays. In the case of the rubbing process, the rubbing brush may be moved along a circumferential direction of the substrate, or the substrate may be rotated relative to the rubbing brush with a center of the substrate as a rotation axis. In the case of the photo-alignment process, an ultraviolet light source that irradiates polarized ultraviolet rays may be moved along the circumferential direction of the substrate, or the substrate may be rotated relative to the ultraviolet light source with the center of the substrate as the rotation axis. In this case, the alignment process directions of the alignment films (the first alignment film 201 and the second alignment film 202) formed on the two substrates (the first substrate 11 and the second substrate 12) are set to be opposite to each other when the two substrates are placed facing each other.

Next, the two substrates (the first substrate 11 and the second substrate 12) opposed to each other are separated from each other so that the alignment films formed on the respective substrates face each other, and the liquid crystal mixture is filled between the two substrates and sealed with a sealant to form a liquid crystal cell (liquid crystal cell 210) (S305). Here, the liquid crystal mixture includes a liquid crystal material and a photopolymerizable liquid crystal monomer. The photopolymerizable liquid crystal monomer is a photocurable resin, in this case an ultraviolet curable resin. The liquid crystal mixture may further comprise a photopolymerization initiator.

The formed liquid crystal cell is irradiated with UV light (S307), and the photopolymerizable liquid crystal monomer in the liquid crystal cell is polymerized to form a polymer structure (polymer structure 132).

As described above, in the present embodiment, it is possible to manufacture the display device 1 capable of achieving high efficiency and high luminance by performing an alignment process in the circumferential direction of the substrate in the alignment process step on the alignment film formed on the substrate.

In the present embodiment, the first alignment film 201 and the second alignment film 202 have a circular shape matching the shape of the display area DA. If the display panel 10 has an arc shape at least in part of an outer edge portion and the display area DA has a similar shape, the first alignment film 201 and the second alignment film 202 have an arc shape at least in a part of outer edge portions. In this case, the alignment process step of S303 includes performing an alignment process on at least a part of each of the surfaces to be aligned 201a and 202a of the alignment film (the first alignment film 201 and the second alignment film 202) along a circumferential direction of the arc shape.

### Second Embodiment

In the first embodiment, a case has been described in which the display panel 10 has an arc shape in at least a part of the outer edge portion. However, the shape of the display panel in the display device of the present invention is not limited to the case where at least a part of the outer edge portion has an arc shape, and the display panel may have a polygonal shape other than a line-symmetrical square in a plan view.

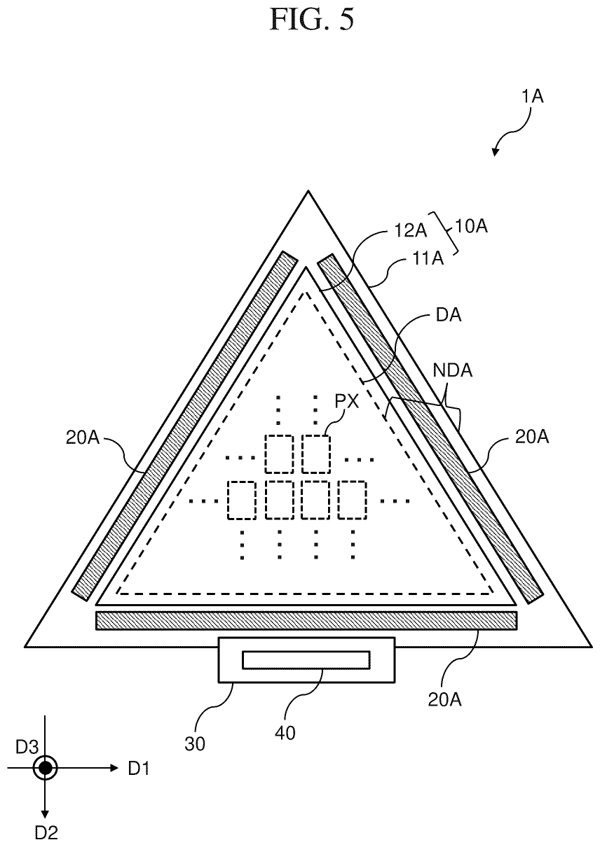

FIG. 5 is a plan view showing an example of a display device 1A according to the present embodiment. The display device 1A is a reverse-mode driving PDLC display device using polymer dispersed liquid crystal as in the display device 1 of the first embodiment. The display device 1A includes a display panel 10A, a light source 20A, the wiring substrate 30, and the driver IC 40.

The display panel 10A includes a first substrate 11A, a second substrate 12A, and a liquid crystal layer (not shown) sandwiched between the first substrate 11A and the second substrate 12A. The display panel 10A has a polygonal shape other than a line-symmetrical square in a plan view. As shown in FIG. 5, in the present embodiment, the display panel 10A has a triangular shape in a plan view.

The first substrate 11A and the second substrate 12A are triangular substrates. The second substrate 12A overlaps at least a part of the first substrate 11A, and the first substrate 11A and the second substrate 12A are bonded to each other while being separated from each other by a sealing material (not shown). The liquid crystal layer (not shown) in the display panel 10A is held between the first substrate 11A and the second substrate 12A, and is sealed with a sealing material, similar to the liquid crystal layer 13 in the display panel 10 of the first embodiment.

The display panel 10A includes the display area DA and the non-display area NDA, and the display area DA has a triangular shape matching the shape of the display panel 10A. The non-display area NDA is arranged so as to surround the display area DA.

In the non-display area NDA, the light sources 20A are arranged so as to surround the display area DA. The light sources 20A are arranged along at least two sides of the respective sides of the display area DA. In the present embodiment, the light sources 20A are arranged along the respective sides of the display area DA. In other words, in the present embodiment, three light sources 20A are arranged so as to correspond to three sides of the triangular-shaped display area DA, respectively.

A configuration of the display device 1A according to the present embodiment is substantially the same as the configuration of the display device 1 according to the first embodiment except for the shapes of the display panel 10A and the display area DA and the arrangement of the light sources 20A.

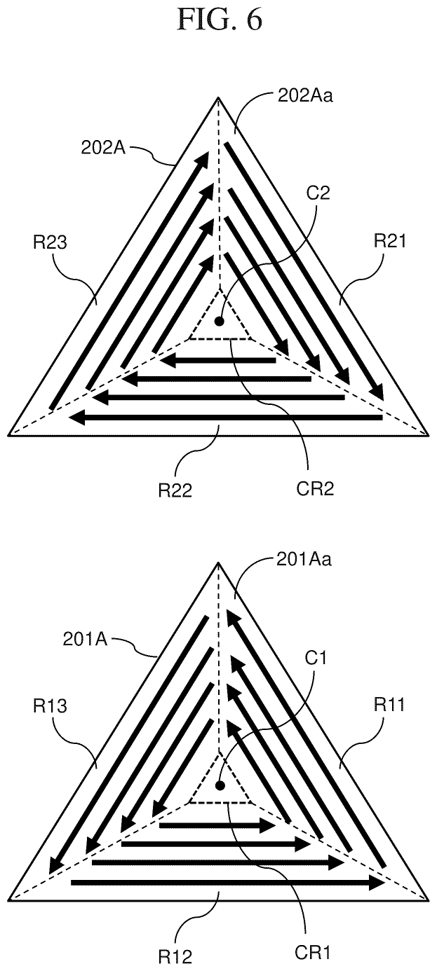

FIG. 6 is a diagram for explaining an alignment process of a first alignment film 201A arranged on the first substrate 11A and a second alignment film 202A arranged on the second substrate 12A. The first alignment film 201A and the second alignment film 202A have a triangular shape matching the shape of the display area DA. At least a part of the surfaces to be aligned of the first alignment film 201A and the second alignment film 202A is subjected to an alignment process along the respective sides of the display panel 10A.

A surface to be aligned 201Aa of the first alignment film 201A and a surface to be aligned 202Aa of the second alignment film 202A shown in FIG. 6 are subjected to an alignment process along each side of the alignment film, that is, along each of the three sides. That is, the surface to be aligned 201Aa of the first alignment film 201A and the surface to be aligned 202Aa of the second alignment film 202A each include three regions that differ from each other in an alignment process direction. Specifically, the surface to be aligned 201Aa of the first alignment film 201A includes a first region R11, a second region R12, and a third region R13 that differ from each other in the alignment process direction. The surface to be aligned 202Aa of the second alignment film 202A includes a first region R21, a second region R22, and a third region R23 that differ from each other in the alignment process direction.

An alignment process direction of the surface to be aligned 201Aa of the first alignment film 201A is opposite to an alignment process direction of the surface to be aligned 202Aa of the second alignment film 202A. The surface to be aligned 201Aa of the first alignment film 201A and the surface to be aligned 202Aa of the second alignment film 202A face each other with the liquid crystal layer interposed therebetween. Here, in the case where the first region R11, the second region R12, and the third region R13 in the surface to be aligned 201Aa of the first alignment film 201A face the first region R21, the second region R22, and the third region R23 in the surface to be aligned 202Aa of the second alignment film 202A, respectively, the alignment process direction of the first region R11 in the surface to be aligned 201Aa and the alignment process direction of the first region R21 in the surface to be aligned 202Aa are opposite to each other. Similarly, the alignment process direction of the second region R12 and the alignment process direction of the second region R22 are opposite to each other, and the alignment process direction of the third region R13 and the alignment process direction of the third region R23 are opposite to each other.

By aligning the surface to be aligned 201Aa of the first alignment film 201A and the surface to be aligned 202Aa of the second alignment film 202A along the respective sides of the alignment film, the alignment process direction and the traveling direction of the light entering the liquid crystal layer 13 from the light source 20A arranged around the display area DA are perpendicular to each other in substantially the entire area of the display area DA. Therefore, when the pixel PX is in the scattering state, regardless of the position of the pixel PX in the display area DA, an angle formed by the traveling direction of the light from the light source 20A and the alignment direction of the liquid crystal molecules 131 in the liquid crystal layer 13 is perpendicular to substantially the entire region of the display area DA. In other words, the light from the light source 20A is perpendicular to the alignment direction of at least a part of the liquid crystal molecules 131 in the liquid crystal layer 13. As a consequence, it is possible to reduce luminance unevenness in the display panel 10A, realize high-efficiency and high-luminance of the display panel 10, and provide the display device 1A having uniform display characteristics.

The manufacturing method of the display device 1A according to the present embodiment is the same as the manufacturing method of the display device 1 according to the first embodiment shown in FIG. 4. Also in the present embodiment, the surfaces to be aligned 201Aa and 202Aa of the first alignment film 201A and the second alignment film 202A are subjected to the alignment process by rubbing or photo-alignment. The alignment process step is performed a number of times corresponding to the alignment process direction of the surfaces to be aligned 201Aa and 202Aa. That is, the alignment process step of S303 in FIG. 4 includes aligning at least a part of the surfaces to be aligned 201Aa and 202Aa of the alignment films (the first alignment film 201A and the second alignment film 202A) along the respective sides of the triangular alignment film. In this case, the center regions CR1 and CR2 including the centers C1 and C2 of the surfaces to be aligned 201Aa and 202Aa of the first alignment film 201A and the second alignment film 202A may not be subjected to an alignment process along the respective sides of the alignment film. The center regions CR1 and CR2 may not be aligned.

In addition, in the present embodiment, although the light source 20A is arranged along each side of the triangular display area DA, the light sources 20A may be arranged along at least two sides of the three sides of the triangular display area DA. In this case, the alignment process step includes performing an alignment process on at least a part of the surfaces to be aligned 201Aa and 202Aa of the alignment films (the first alignment film 201A and the second alignment film 202A) along at least two sides of the triangular alignment film.

### MODIFICATIONS

While embodiments of the present invention have been described above, the present invention can be implemented in various ways as follows.

### (1) Modification 1

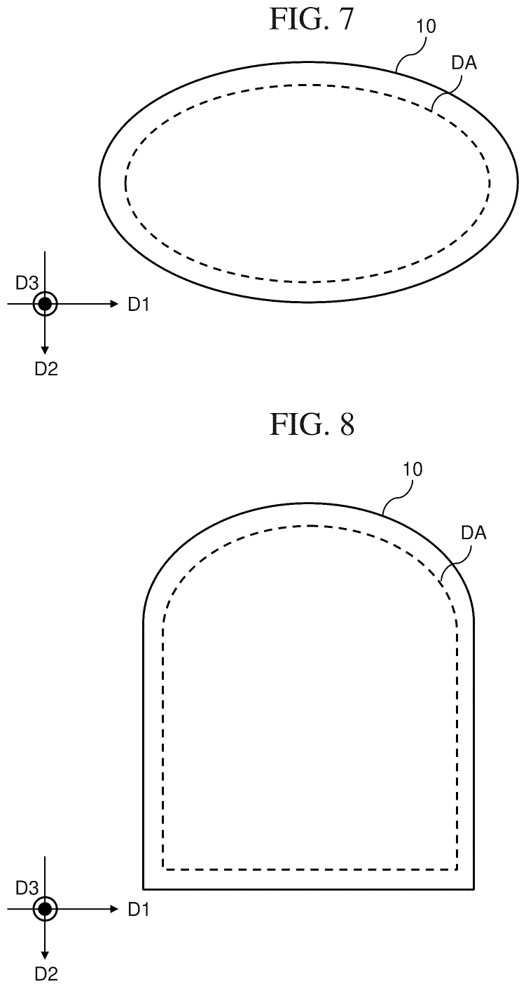

In the first embodiment described above, the case where the shape of the display panel 10 is a circular shape in a plan view has been described as an example. However, it is sufficient that the display panel 10 has a curved portion in at least a part of the outer edge portion. FIG. 7 and FIG. 8 are examples of a plan view of the display panel 10 of the present modification example.

As shown in FIG. 7, the display panel 10 may have an overall elliptical shape in a plan view. Further, as shown in FIG. 8, a part of the outer edge portion of the display panel 10 may have an arc shape in a plan view. Specifically, the outer edge portion of one side (upper side in FIG. 8) of the display panel 10 in the second direction D2 is arcuate, and the other side (lower side in FIG. 8) in the second direction D2 has a rectangular partial shape. The display area DA has a shape matching the shape of the display panel 10.

As shown in FIG. 7, when the display panel 10 has an overall elliptical shape in a plan view, the surfaces to be aligned of the alignment films (the first alignment film 201 and the second alignment film 202) arranged on the respective substrates (the first substrate 11 and the second substrate 12) of the display panel 10 are subjected to an alignment process along the circumferential direction of the display panel 10.

As shown in FIG. 8, in the case where the display panel 10 has an outer edge portion that has an arc shape in a plan view, and the light source 20 (not shown in FIG. 8) is arranged adjacent to the outer edge portion having the arc shape, the surface to be aligned of the alignment film arranged on each substrate of the display panel 10 is subjected to an alignment process along the arc shape of the outer edge portion of the display panel 10 in at least a partial region.

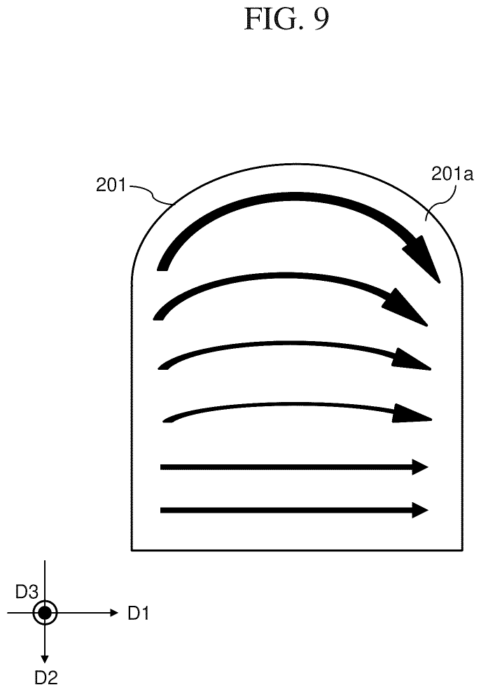

FIG. 9 shows the surface to be aligned of the alignment film used for the display panel 10 shown in FIG. 8. FIG. 9 exemplifies the surface to be aligned 201a of the first alignment film 201. The first alignment film 201 is shaped matching the display area DA of the display panel 10 shown in FIG. 8. In the surface to be aligned 201a of the first alignment film 201, at least an outer edge portion having an arc shape, that is, the vicinity of one side (upper side in FIG. 9) of the first alignment film 201 in the second direction D2 is subjected to an alignment process in a direction along the arc shape of the outer edge. As shown in FIG. 9, the surface to be aligned 201a may be subjected to an alignment process so as to gradually follow a predetermined direction from one side (upper side in FIG. 9) toward the other side (lower side in FIG. 9) in the second direction D2. Although not shown, the surface to be aligned 202a of the second alignment film 202 facing the surface to be aligned 201a is subjected to an alignment process in a direction opposite to the alignment process direction of the surface to be aligned 201a.

### (2) Modification 2

In the second embodiment, the display panel 10A having the triangular shape in a plan view has been described as a display panel having a polygonal shape other than a linearly symmetric rectangle in a plan view. However, the polygonal shape is not limited to a triangular shape, and may be a pentagonal shape, a hexagonal shape, an octagonal shape, or the like. In addition, the display panel 10A may have an asymmetric square shape. In this case, the light sources 20A may be arranged along at least two sides of the respective sides of the polygonal display area DA. In this case, the alignment process step includes performing an alignment process on at least a part of each of the surfaces to be aligned 201Aa and 202Aa of the alignment films (the first alignment film 201A and the second alignment film 202A) along at least two sides of the polygonal alignment film.

### (3) Modification 3

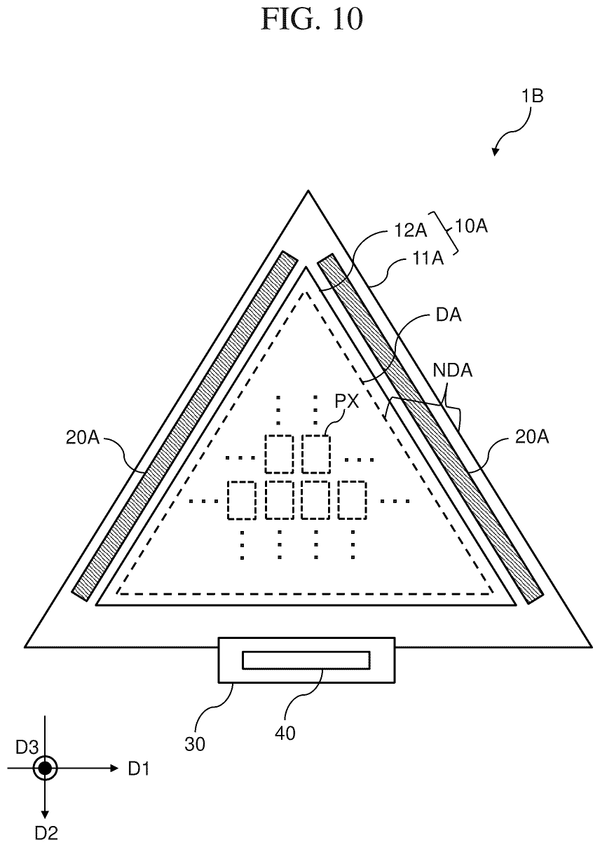

In the second embodiment, the light source 20A is arranged corresponding to each side of the triangular-shaped display panel 10A. However, as shown in FIG. 10, the light source 20A may be arranged along two of the three sides of the display panel 10A. In a display device 1B shown in FIG. 10, the light sources 20A are arranged on the remaining two sides respectively, except the side to which the wiring board 30 is connected. In FIG. 10, although the wiring board 30 is arranged on a side where the light source 20A is not arranged, the position of the wiring board 30 is not limited thereto.

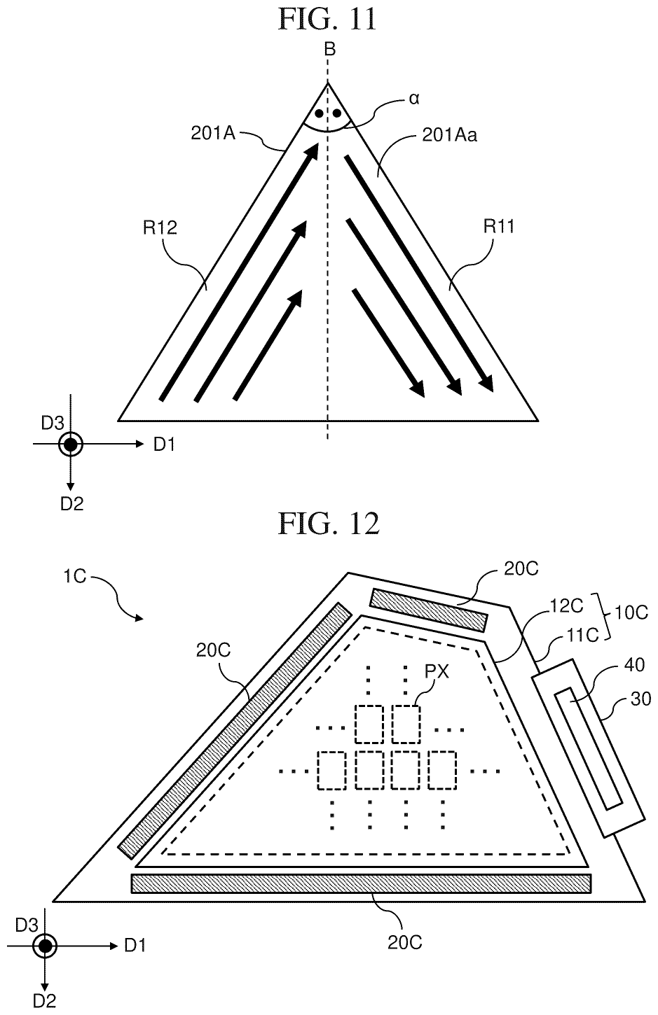

FIG. 11 shows a surface to be aligned of an alignment film used in the display panel 10A shown in FIG. 10. FIG. 11 shows, as an example, the surface to be aligned 201Aa of the first alignment film 201A. The first alignment film 201A is shaped matching the display area DA of the display panel 10A shown in FIG. 10. The surface to be aligned 201Aa is subjected to an alignment process along each of the two sides adjacent to the light source 20A. In other words, the surface to be aligned 201Aa includes two regions in which the alignment process directions differ from each other. Specifically, the surface to be aligned 201Aa includes the first region R11 and the second region R12 that differ from each other in the alignment process direction. A border line B defining the first region R11 and the second region R12 corresponds to a line bisecting an angle α formed by the two sides adjacent to the light source 20A. Although not shown, the surface to be aligned 202Aa of the second alignment film 202A facing the surface to be aligned 201Aa is subjected to an alignment process in a direction opposite to the alignment process direction.

FIG. 12 shows a display device 1C including a display panel 10C having a configuration different from the display panel 10A of the display device 1B shown in FIG. 10. The display panel 10C has an asymmetric square shape.

Here, light sources 20C are arranged on three sides of the four sides of the display panel 10C, respectively. In FIG. 10, although the wiring board 30 is arranged on a side where the light source 20C is not arranged, the position of the wiring board 30 is not limited thereto.

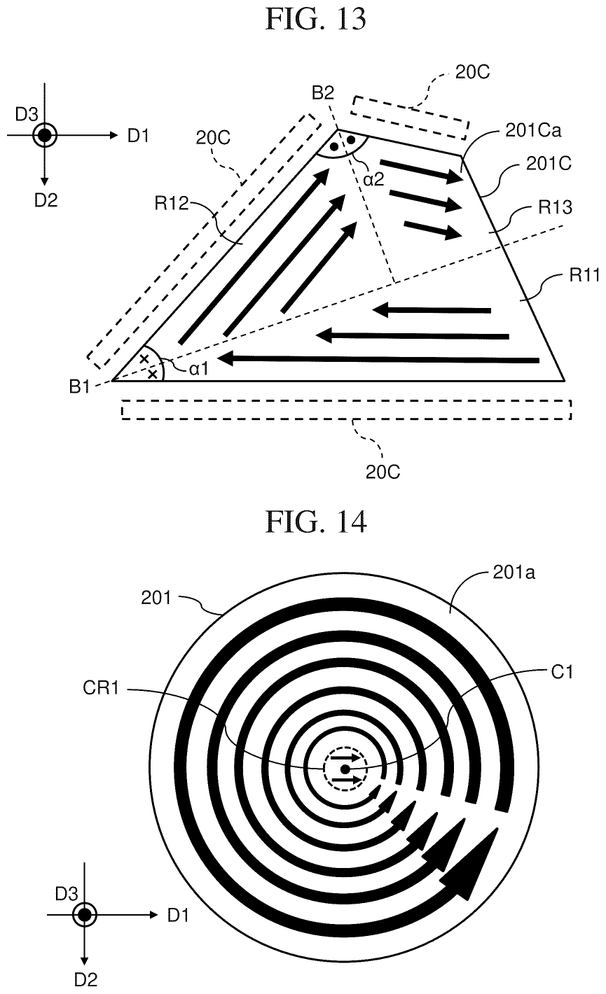

FIG. 13 shows a surface to be aligned of an alignment film used in the display panel 10C shown in FIG. 12. FIG. 13 shows, as an example, a surface to be aligned 201Ca of a first alignment film 201C. The first alignment film 201C is shaped matching the display area DA of the display panel 10C shown in FIG. 12. The surface to be aligned 201Ca is subjected to an alignment process along each of the three sides adjacent to the light source 20C. In other words, the surface to be aligned 201Ca includes three regions in which the alignment process directions differ from each other. Specifically, the surface to be aligned 201Ca includes the first region R11, the second region R12, and the third region R13 that differ from each other in the alignment process direction. A border line B1 and a border line B2 defining the first region R11, the second region R12 and the third region R13 correspond to lines that bisect the angles α1 and α2, respectively, made by two sides adjacent to the light source unit 20C. Although not shown, a surface to be aligned of a second alignment film facing the surface to be aligned 201Ca is subjected to an alignment process in a direction opposite to the alignment process direction of the surface to be aligned 201Ca.

### (4) Modification 4

In the first embodiment and the second embodiment, the center region CR1 of the surface to be aligned 201a and 201Aa of the first alignment films 201 and 201A, and the center region CR2 of the surface to be aligned 202a and 202Aa of the second alignment films 202 and 202A may not be subjected to the alignment process. However, the center regions CR1 and CR2 may be orientated in a predetermined direction.

FIG. 14 shows, as an example, a case where the center region CR1 of the surface to be aligned 201a of the first alignment film 201 is subjected to the alignment process along the first direction D1 in the first embodiment. The alignment process direction of the center region CR1 is not limited to the first direction D1. Although not shown, in the surface to be aligned 202a of the second alignment film 202 facing the surface to be aligned 201a, the center region CR2 is subjected to an alignment process in a direction opposite to the alignment process direction of the center region CR1. The alignment process step is performed a number of times corresponding to the alignment process direction of the surface to be aligned 201a. Further, the alignment process of the center region of the alignment film in a predetermined direction can also be applied to the second embodiment and each of the modifications described above.

What is claimed is:

1. A display device comprising:
a display panel including a first substrate, a second substrate, and a liquid crystal layer between the first substrate and the second substrate; and
a light source arranged around the display panel, wherein
at least a part of a periphery of the display panel has a curved portion in a plan view,
the liquid crystal layer contains liquid crystal molecules and a polymer, and
part of the liquid crystal molecules is aligned along the curved portion.

2. The display device according to claim 1, wherein the display panel has a circular shape.

3. The display device according to claim 1, wherein the display panel has an oval shape.

4. The display device according to claim 1, wherein light from the light source is perpendicular to an alignment direction of at least a part of the liquid crystal molecules.

5. The display device according to claim 2, wherein light from the light source is perpendicular to an alignment direction of at least a part of the liquid crystal molecules.

6. The display device according to claim 3, wherein light from the light source is perpendicular to an alignment direction of at least a part of the liquid crystal molecules.

7. The display device according to claim 1, wherein
the display panel has a central region including a center of the display panel, and
some of the liquid crystal molecules that are located in the center region are aligned in a direction different from a direction along the curved portion.

8. A display device comprising:
a display panel including a first substrate, a second substrate, and a liquid crystal layer between the first substrate and the second substrate; and
a light source arranged around the display panel, wherein
the liquid crystal layer contains liquid crystal molecules and a polymer,
the display panel has a polygonal shape other than a square,
the light source is arranged along at least one side of the display panel, and
at least a part of the liquid crystal molecules is aligned along the at least one side of the display panel.

9. The display device according to claim 8, wherein the display panel has a triangular shape, pentagonal shape, or hexagonal shape.

10. The display device according to claim 8, wherein light from the light source is perpendicular to an alignment direction of at least a part of the liquid crystal molecules.

11. The display device according to claim 9, wherein light from the light source is perpendicular to an alignment direction of at least a part of the liquid crystal molecules.

12. The display device according to claim 8, wherein
the display panel has a central region including a center of the display panel, and
some of the liquid crystal molecules that are located in the central region are aligned in a direction different from a direction along the curved portion.
